(19) United States
(12) Patent Application Publication
(10) Pub. No.: US 2005/0088916 A1
(43) Pub. Date: Apr. 28, 2005

(54) Water acoustic coherently communication system and signal processing method having high code rate, low probability of error

(76) Inventors: Weiqing Zhu, Haidian District Beijing (CN); Min Zhu, Haidian District Beijing (CN); Changhong Wang, Haidian District Beijing (CN); Feng Pan, Haidian District Beijing (CN)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/500,328

(22) PCT Filed: May 28, 2002
(86) PCT No.: PCT/CN02/00360

(30) Foreign Application Priority Data
Dec. 30, 2001 (CN) 01145134.3

(51) Int. Cl. H04B 11/00; H04B 13/02

(52) U.S. Cl. 367/134

(57) ABSTRACT

The present invention relates to a method and a system of a high code speed low error probability underwater acoustic coherent communication for underwater transferring instruction, data and image. The communication system includes a host machine installed on a mother ship or a main control underwater vehicles A and a guest machine installed on an underwater vehicle B, wherein the host machine comprises an electronic subassembly, a transducer and a receiving line array which is vertically deployed and consists of more than two hydrophones, and the guest machine comprises an electronic subassembly and a transmitting/receiving transducer. The signal processing method of the present invention is based on the joint technology of the space diversity, the self-optimized adaptive decision feedback equalizer and self-optimized adaptive phase tracker so as to overcome the affection of motion of the channel and the vehicles, such that the received signal could be quite close to the transmitted signal, and the bit error probability is low.

### BACKGROUND OF THE INVENTION

1. Field of the Invention

The present invention relates to a method and a system for underwater acoustic communication, and more particularly to a method and a system for a high code rate and low error probability underwater acoustic coherent communication.

2. Description of Related Art

Conventional method and system for underwater acoustic coherent communication are known in the art, following patents are references for example:

(1) U.S. Pat. No. 5,844,951 of “Method and apparatus for simultaneous beam forming and equalization” entitled J. G. Proakis et al., has introduced a method and an apparatus for combination and equalization of multiple channels in a multi-channel receiver, which is capable of combination, equalization and synchronization in simultaneous. The method and apparatus of this patent utilizes an adaptive multi-channel receiver with a reduced complexity in the underwater acoustic data communication system. The underwater coherent communication system of the above-mentioned patent is generally provided with a receiver, as shown in FIG. 1, the system comprises:
(A) a multi-channel receiver for accomplishing of spatial diversity including channels 1 . . . K, as shown in FIG. 1;
(B) a decision feedback adaptive equalizer (DFE) having a front section including channels a₁(n) . . . aₖ(n), and a feedback section b(n), and accomplishing adaptive equalization based on a fast convergent recursive least squares (RLS) algorithm;
(C) a phase tracker for signal synchronization including phase estimators p₁(n) . . . pₖ(n), as shown in FIG. 1, to achieve phase tracking by means of a second order digital phase-locked loop (DPLL).

(2) U.S. Pat. No. 6,130,859 of “Method and apparatus for carrying out high data rate and voice underwater communication” entitled Sonnenschein et al., has introduced a method and an apparatus for transmitting and receiving high speed data and voice underwater communication, wherein said apparatus comprises a transmitter, a receiver, and a Doppler frequency shift compensator. The Doppler compensator measures the frequency of at least one of two unmodulated signals transmitted as part of the modulated signal and compares the measured frequency with a predetermined frequency, thereby a Doppler frequency shift value being achieved.

Presently, the conventional underwater acoustic coherent communication systems still have following major drawbacks: (1) they are not able to detect and track phase of signal rapidly that may result in equalizer tap rotation and the equalizer may be abated. The communication system according to the U.S. Pat. No. 5,844,951 utilizes a second order digital phase-locked loop (DPLL) to detect and track phase, wherein two coefficients of the equalizer are fixed, therefore it is not able to adapt the rapid time varying feature of the underwater communication channel. When the motion speed of the channel boundary, water volume and the vehicle etc. exceed 0.14 m/s, the second order digital phase-locked loop (DPLL) is abated. The apparatus for underwater acoustic communication as disclosed in U.S. Pat. No. 6,130,859 transmits at least one of two unmodulated signals and compares the measured frequency with a predetermined frequency so as to achieve a Doppler frequency shift value, which is an average Doppler frequency shift for this transmission. For rapid time varying underwater communication channel, it is not adequate to track signal phase, and also not adequate to represent the speed of the motion for wide band signal; (2) in the communication system of U.S. Pat. No. 5,844,951, a recursive least squares (RLS) algorithm is used to achieve adaptive equalization, the test result shows that it is unable to track with the varying of the communication channel when the channel is relatively complex the equalizer is abated;

(3) the amount of the adaptive equalizer coefficients in U.S. Pat. No. 5,844,951 is more than several tens, so that the computation is complex, and the requirements for hardware are high.

### SUMMARY OF THE INVENTION

A main object of the present invention is to overcome the drawback of the conventional underwater acoustic coherent communication system and method, which are unable to detect and track the rapidly varying signal phase.

A further object of the present invention is to overcome the drawback of the adaptive decision feedback equalizer of the conventional underwater acoustic coherent communication system and method, which are unable to detect and track the rapidly varying signal.

Another object of the present invention is to provide an improved underwater acoustic coherent communication system with less coefficient number of the adaptive decision feedback equalizer to simplify the complexity of the hardware of the system.

Yet another object of the present invention is to provide an improved high code rate low error probability underwater acoustic coherent communication system and method to overcome the underwater multi-path effect.

The objects of the present invention are achieved by providing a high code rate low error probability underwater acoustic coherent communication system, which includes a host machine installed on a mother ship or main control underwater vehicle A and a guest machine installed on a second ship or a second underwater vehicle B, wherein the host machine comprises a transmitting transducer, a receiving line array and an electric subassembly, the transmitting transducer and the receiving line array are lowered down into water from the mother ship or the main control underwater vehicle A and electrically connected to a transmitter and a multi-channel receiver of the electric subassembly of the host machine respectively; The guest machine comprises a transmitting/receiving transducer and an electric subassembly, the transmitting/receiving transducer is lowered down into water from the second ship or installed in the second underwater vehicle B and electrically connected to a transmitter and a receiver of the electric subassembly of the guest machine respectively. What is characterized is that the center frequency of the communication system is ranged from 7 kHz to 45 kHz, the bandwidth is ranged from 5 kHz to 20 kHz, the receiving line array of the host machine consists of 2 to 16 hydrophones and vertically deployed with space from 8 to 40 wave lengths, each hydrophone being non-directive in the horizontal, and the receiving sensitivity frequency response satisfy the predetermined bandwidth of the system.

Said transmitting transducer of the host machine or the transmitting/receiving transducer of the guest machine may be a non-directive transducer or a directive transducer with beam angle ranged from 60° to 120°.

Said electric subassembly of the host machine comprises a transmitter, a multi-channel receiver, a multi-channel data sampler, a high speed digital signal processor, an input/output interface and a main control computer, wherein the receiver is electrically connected to the multi-channel data sampler, the multi-channel data sampler is electrically connected to high speed digital signal processor, which is electrically connected to a main control computer, and the input/output interface is electrically connected to the main control computer, the transmitter and the multi-channel receiver.

Said electric subassembly of the guest machine comprises a transmitter, an single channel receiver, a data sampler, high speed digital signal processor, an input/output interface and a main control computer, wherein the transmitting/receiving transducer is electrically connected with the receiver and the transmitter, the receiver is electrically connected to the data sampler, the data sampler is electrically connected to the high speed digital signal processor, input/output interface is electrically connected with the transmitter, the single channel receiver, and the main control computer.

Said transmitters of the host and guest machine are operating under the control of the program, which controls the starting, the stopping and the waveform of the transmitter through the input/output interface. The large power pulse signal drives the transducer to transmit sound wave into the water. The peak power of the transmitter should not be less than 5 W.

Said multi-path receiver of the host machine consists of 2 to 16 channel receivers, each channel is connected to one hydrophone. The center frequency of each channel is ranged from 7 kHz to 45 kHz, and the bandwidth is ranged from 5 kHz to 20 kHz. Each channel has a gain of no less than 40 dB, and has an automatic gain control circuit in addition to a band pass filter for filtering noise and interference. The automatic gain control is accomplished by means of the feedback circuit or alternative software for computing the signal amplitude and adjusting gain through the input/output interface. The receiver may utilize a quadrature mixing circuit for output of quadrature base band signal or alternatively output carrier signal without mixing. The signal amplitude satisfies the requirement of the multi-channel data sampler.

Said data sampler of the host machine includes many channels, the number of which is not less than the number of channels of the receiver, and the sampling speed for each channel is equal to or more than 4 times of the output signal bandwidth of the receiver, the bit number of the AD converter is not less than 10 bits.

The sampling rate of the data sampler of the guest machine is not lower than 4 times of the bandwidth of the receiver, and the bit number of the A/D converter is not lower than 10 bits.

Said high speed digital signal processor of the host machine is used to perform real-time processing of the digitized signal and to recover the carried information from it by processing the signal based on the joint algorithms of space diversity, self-optimized multi-channel adaptive decision feedback equalization and self-optimized adaptive phase tracker. The processing capacity of said high speed digital signal processor of the host machine is not lower than 400 MIPS, the RAM is not lower than 256 k bytes, the data throughput between the digital signal processor and the multi-channel data sampler is not lower than the data output rate of the multi-channel data sampler.

Said high speed digital signal processor of the guest machine is used to perform real-time processing of the digitized echo signal and to recover the carried information from it by processing the signal based on the joint algorithms of self-optimized adaptive decision feedback equalization and self-optimized adaptive phase tracker. The processing capacity of said high speed digital signal processor of the guest machine is not lower than 33 MIPS, the RAM is not lower than 128 k bits, the data throughput between the digital signal processor and the multi-channel data sampler is not lower than the data throughput of the multi-channel data sampler.

Said input/output interface of the host and guest machines provide computer and high speed digital signal processor of the electric subassembly with digital and analog interface with the multi-/single-channel receiver, transmitter, power supply and the wakeup circuit. At least one DA output with a resolution not lower than 10 bits and refresh rate not less than 30 k SPS is required to send the multiple phase shift keying (MPSK) modulated signal to the transmitter.

The present invention provides a method for processing underwater acoustic coherent signal with the high code rate low error probability underwater acoustic coherent communication system of the present invention. The method of the invention includes a signal transmitting step, a signal receiving step, and a processing step for the received signal.

The signal transmitting step of the host and guest machine includes first modulating the source data, sending the modulated data to the transmitter via the input/output interface, and driving the transmitting transducer or the transmitting/receiving transducer to emit acoustic signal; the receiving step of the host machine includes converting the acoustic signal propagating to the hydrophones of the receiving line array of the host machine into electrical signal, conditioning them in the multi-path receiver, and digitizing them in the multi-channel data sampler. The receiving step of the guest machine includes converting the acoustic signal propagating to the transmitting/receiving transducer of the guest machine into electrical signal, conditioning the signal in the receiver, and digitizing them in the data sampler.

The processing of the received signal-includes: processing the digitalized signal in the high speed digital signal processor, saving the processing result in a hard disk, or sending the result to other terminals through serial ports. What is characterized is that the modulating method is the multiple phase shift keying modulation, the host machine utilizes a multi-hydrophone receiving line array, a multi-channel receiver and multi-channel data sampler to realize space diversity; the processing step including processing signal based on the joint algorithm of space diversity, self-optimized multi-channel adaptive decision feedback equalizer and the optimization adaptive phase tracker, wherein the self-optimized multi-channel adaptive decision feedback equalizer utilizes an algorithm of the fast optimization least mean square, the gain factor μ of which is adaptively adjusted based on the algorithm of least mean square (LMS), the self-optimized adaptive phase tracker provides phase compensation to the multi-channel signals based on the algorithm of fast optimization least mean square, the gain factor λ of which is adaptively adjusted based on the algorithm of least mean square (LMS).

The underwater acoustic coherent communication system of the present invention processes signal based on the joint algorithm of space diversity, self-optimized adaptive decision feedback equalizer and self-optimized adaptive phase tracker. The corresponding coherent receiver based on the self-optimized adaptive multi-channel adaptive decision feedback equalizer (DFE) is shown as referred in FIG. 1. What is characterized is that the self-optimized multi-channel decision feedback equalizer utilizes a fast optimization least mean square (FOLMS) algorithm, the gain factor μ of which is adaptively adjusted based on LMS algorithm, the self-optimized adaptive phase tracker provides phase compensation to multi-channel signals based on fast optimization least mean square (FOMLS) algorithm, the gain factor [symbol] of which is adaptively adjusted based on the algorithm of least mean square (LMS).

The transmitting procedure of the high code rate low error probability underwater acoustic coherent communication system of the present invention is as follows:

The source data is fed to the high speed digital signal processor from the main control computer, re-organized into packages, encoded, modulated into digital waveform, fed to the input/output interface, DA converted and amplified by the transmitter to generate high-power multi-phase shift keying (MPSK) electric pulse signal to drive the transmitting transducer to emit acoustic signal into water.

The receiving procedure of the high code rate low error probability underwater acoustic coherent communication system of the present invention is as follows:

The transmitted acoustic signal is received by the receiving array of the host machine or the transmitting/receiving transducer of the guest machine. The received signal is conditioned in the receiver and digitized in the digital sampler, then the digital signal is fed into the high speed digital signal processor for further processing, afterwards the result of the digital signal processor is fed into the computer and saved in the hard disk or fed to other alternative terminals through serial ports.

The operating procedure of the high code rate low error probability underwater acoustic coherent communication system of the present invention is as follows:

The communication between the host machine and the guest machine is a half-duplex operation mode, which starts from the host machine. First, the host machine transmits a wakeup signal and wait for the response from the guest machine. The host machine will repeatedly transmit the wakeup signal until the guest machine replies. The guest machine is usually under a lower power consumption status, and comes to a normal operating status in case of a wakeup signal is received by the wakeup circuit and the other circuits of the guest machine is activated by the wakeup signal. When the guest machine comes to the normal operating status, it sends a response signal back to the host machine. After the host machine has received a response signal from the guest machine, the data to be transmitted will be packed, encoded, modulated and transmitted. The guest machine receives the sound and performs a real-time processing so as to recover the data transmitted from the host machine. Having the host machine completed the transmitting, the guest machine will transmit data to the host machine as return. The data is first packed, encoded and modulated by the guest machine, and then transmitted out. The host machine is always under the receiving status while it is not under the transmitting status. The host machine receives the sound signal sent from the guest machine, processes the sound signal in real-time and recovers the data transmitted from the guest machine.

The advantages of the present invention includes: (1) the underwater acoustic communication channel is regarded as divergent patterns in both time and frequency fields according to the high code rate low error probability underwater acoustic communication system and signal processing method of the present invention, and the phase of the underwater acoustic signal is regarded as a fast varying random parameter. The self-optimized adaptive phase tracker of the present invention denoted as p₁(n)-pₖ(n) in FIG. 1 is a phase estimator utilizing a least means square (LMS) algorithm, which is suitable for estimation of random parameter. Different from the ordinary LMS algorithm which regards the gain factor [symbol] as a fixed parameter, the gain factor [symbol] in the LMS algorithm according to the present invention is regarded as a random parameter and also estimated by an LMS algorithm, i.e. the gain factor [symbol] is optimized automatically, accordingly, the phase tracker of the present invention utilizes a dual layers LMS algorithm so as to enable the tracker to track the fast varying parameter, i.e. the phase of the signal.

(2) the underwater acoustic communication channel is regarded as divergent patterns in both time and frequency fields according to the high code rate low error probability underwater acoustic communication system and signal processing method of the present invention, and the amplitude of the underwater signal is regarded as a fast varying random parameter. The self-optimization adaptive decision feedback equalizer of the present invention denoted as a₁(n)-a₂(n) and b(n) in FIG. 1 is an equalizer utilizing a least means square (LMS) algorithm. Different from the common LMS algorithm which regards the gain factor μ as a fixed parameter, the gain factor μ in the LMS algorithm according to the present invention is regarded as a random parameter and also estimated by an LMS algorithm, i.e. the gain factor μ is optimized automatically, accordingly, the self-optimization adaptive decision feedback equalizer of the present invention utilizes a dual layers LMS algorithm, so as to track the fast varying parameter, i.e. the amplitude of the signal.

(3) the LMS algorithm used in the high code rate low error probability underwater acoustic communication system and signal processing method of the present invention is simplified in comparison with the RLS (recursive least squares) algorithm, and the order numbers of the self-optimized adaptive phase tracker and the self-optimized adaptive decision feedback equalizer are less than 11, due to the dual layer LMS algorithm.

(4) the high code rate low error probability underwater acoustic communication system and signal processing method of the present invention has been tested several times at different distances. The host and guest machine are respectively installed on a mother ship and a second ship. The communication channel is most complex at the distance of 2000 meters. The test results are illustrated in FIGS. 12 and 13. FIG. 12 illustrates the test result achieved by means of the space diversity, self-optimized adaptive decision feedback equalizer and self-optimized adaptive phase tracker of the present invention, the error probability being 1.9×10⁻⁵. FIG. 13 illustrates the test result achieved by means of the space diversity, the fast convergent recursive least square (RLS) and the second order digital phase-locked loop of the U.S. Pat. No. 5,844,951, the error probability being 1.95×10⁻². It can be seen that the test result of the present invention is apparently better than that of the U.S. Pat. No. 5,844,951.

(5) it can be seen in the test result shown in the FIG. 14, the error probability of the communication system of the present invention is maintain at 10⁻⁵, when the relative speed is equal and less than 1.4 m/s. It is apparently better than 0.14 m/s achieved in the U.S. Pat. No. 5,844,951.

(6) as shown in FIG. 15, different results are achieved at different distance tests. It shows that the received images only have minor difference compared with the original image. For example, at a range of 4000 meters, data rate of 10 kbits/s, the error probability is lower than 10⁻⁴, thereby range x data rate equals to 40 km×kbits/s, comes up to the upper limit of the international level in the nineties of the twenty century, as shown in FIG. 16, the curve in the drawing is the upper limit, the symbol * is the result achieved with the present invention.

### BRIEF DESCRIPTION OF THE DRAWINGS

FIG. 1 is a block diagram of a coherent receiver based on an adaptive multi-channel decision feedback equalizer (DFE);

FIG. 2 is a diagram of an underwater acoustic coherent communication system in accordance with the present invention;

FIG. 3 is a block diagram of a host machine of the underwater acoustic coherent communication system in accordance with the present invention;

FIG. 4 is a block diagram of a guest machine of the underwater acoustic coherent communication system in accordance with the present invention;

FIG. 5 is a block diagram of a transmitter of the underwater acoustic coherent communication system in accordance with the present invention;

FIG. 6 is a block diagram of one channel of the receiver of the underwater acoustic coherent communication system in accordance with the present invention;

FIG. 7 is a block diagram of a sampler of the underwater acoustic coherent communication system in accordance with the present invention;

FIG. 8 is a block diagram of a high speed digital signal processor of the underwater acoustic coherent communication system in accordance with the present invention;

FIG. 9 is a block diagram of input/output port of the underwater acoustic coherent communication system in accordance with the present invention;

FIG. 10 is a block diagram of a wake-up circuit of the underwater acoustic coherent communication system in accordance with the present invention;

FIG. 11a is a flow diagram of a transmitting program of the underwater acoustic coherent communication system in accordance with the present invention;

FIG. 11b is a flow diagram of a receiving program of the underwater acoustic coherent communication system in accordance with the present invention;

FIG. 11 is a flow diagram of the program of the underwater acoustic coherent communication system in accordance with the present invention;

FIG. 12a is a diagram illustrating the relationship between gain factor [symbol] of an LMS estimator in a phase tracker and the symbol numbers in accordance with the present invention;

FIG. 12b is a diagram illustrating the relationship between gain factor μ of an LMS estimator in an adaptive equalizer and symbol numbers in accordance with the present invention;

FIG. 12c is a diagram illustrating the relationship between mean square error (MSE) and symbol numbers of the analysis result in accordance with the present invention;

FIG. 12d is a diagram illustrating the relationship between 3-channel phase estimation and symbol numbers of the analysis result in accordance with the present invention;

FIG. 12e is an output constellation diagram illustrating the analysis result in accordance with the present invention;

FIG. 12f is a diagram illustrating the symbol error distribution of the analysis result in accordance with the present invention;

FIG. 12 are diagrams illustrating the analysis result in accordance with the present invention based on the joint algorithm of the spatial diversity, self-optimized adaptive decision feedback equalizer and self-optimized adaptive phase tracker under the most complex channel in the tests, wherein the signal is QPSK modulated, the data rate is 10 kbits/s, the communication range is 2000 m, the bit error probability is 1.90×10⁻⁵, the equalizer coefficient number [a₁; a₂; a₃; b]=[1; 1; 1; 11];

FIG. 13a is a diagram illustrating the relationship between mean square error (MSE) and symbol numbers of the analysis result in accordance with the U.S. Pat. No. 5,844,951;

FIG. 13b is a diagram illustrating the relationship between 3-channel phase estimation and symbol numbers of the analysis result in accordance with the U.S. Pat. No. 5,844,951;

FIG. 13c is an output constellation diagram illustrating the analysis result in accordance with the U.S. Pat. No. 5,844,951;

FIG. 13d is a diagram illustrating the symbol error distribution of the analysis result in accordance with the U.S. Pat. No. 5,844,951;

FIG. 13 are diagrams illustrating the analysis result in accordance with the U.S. Pat. No. 5,844,951 based on algorithm of the spatial diversity, the fast convergent recursive least squares (RLS) and the second-order digital phase-locked loop under the most complex channel in the tests, wherein the signal is QPSK modulated, the data rate is 10 kbits/s, communication range is 2000 m, bit error probability is 1.95×10⁻², number of coefficients [a₁; a₂; a₃; b]=[2; 2; 2; 12];

FIG. 14a is a diagram illustrating the relationship between mean square error (MSE) and symbol numbers of a simulation result in accordance with the present invention;

FIG. 14b is a constellation diagram illustrating the simulation result in accordance with the present invention;

FIG. 14c is a diagram illustrating the relationship between the phase and the symbol numbers of the simulation result in accordance with the present invention;

FIG. 14d is a diagram illustrating the symbol error distribution of the simulation result in accordance with the present invention;

FIG. 14 are diagrams illustrating the simulation result in accordance with the present invention based on the joint algorithm of spatial diversity, self-optimized adaptive decision feedback equalizer and self-optimized adaptive phase tracker, wherein the signal is QPSK modulated, the data rate is 10 kbits/s, the signal to noise ratio is 15 dB, the relative speed is 1.4 m/s, the bit error probability is 10⁻⁵,

FIG. 15 is a comparison of transmitted original image and images received via the system of the present invention. There are only minor difference.;

FIG. 16 is a graphic illustrating the range—data rate capability of conventional underwater acoustic communication system, the curve in it representing the upper limit, the asterisk (*) representing the capability achieved by the system in accordance with the invention;

FIG. 17 illustrates the experimental configuration of one practicing embodiment of the system in accordance with the present invention on a lake;

FIG. 18a is a diagram illustrating the relationship between gain factor [symbol] of an LMS estimator in a phase tracker and symbol numbers in accordance with the present invention;

FIG. 18b is a diagram illustrating the relationship between gain factor μ of an LMS estimator in an adaptive equalizer and symbol numbers in accordance with the present invention;

FIG. 18c is a diagram illustrating the relationship between mean square error (MSE) and symbol numbers of the analysis result in accordance with the present invention;

FIG. 18d is a diagram illustrating the relationship between 3-channel phase estimation and symbol numbers of the analysis result in accordance with the present invention;

FIG. 18e is an output constellation diagram illustrating the analysis result in accordance with the present invention;

FIG. 18f is a diagram illustrating the symbol error distribution of the analysis result in accordance with the present invention;

FIG. 18 are diagrams illustrating the analysis result in accordance with the present invention based on the joint algorithm of spatial diversity, self-optimized adaptive decision feedback equalizer and self-optimized adaptive phase tracker, wherein the signal is QPSK modulated, the data rate is 10 kbits/s, the communication distance is 4000 m, the bit error probability is 1.75×10⁻⁵, the equalizer coefficient number [a₁; a₂; a₃; b]=[2; 2; 2; 9];

FIG. 19a is a diagram illustrating the relationship between mean square error (MSE) and symbol numbers of the analysis result in accordance with the U.S. Pat. No. 5,844,951;

FIG. 19b is a diagram illustrating the relationship between channel phase estimation and symbol numbers of the analysis result in accordance with the U.S. Pat. No. 5,844,951;

FIG. 19c is an output constellation diagram illustrating the analysis result in accordance with the U.S. Pat. No. 5,844,951;

FIG. 19d is a diagram illustrating the symbol error distribution of the analysis result in accordance with the U.S. Pat. No. 5,844,951;

FIG. 19 are diagrams illustrating the analysis result in accordance with the U.S. Pat. No. 5,844,951 based on algorithm of the spatial diversity, the fast convergent recursive least squares (RLS) and the second-order digital phase-locked loop, wherein the signal is QPSK modulated, the data rate is 10 kbits/s, the communication distance is 4000 m, the bit error probability is 2.15×10⁻².

### DETAILED DESCRIPTION OF THE PREFERRED EMBODIMENT

As shown in FIG. 2 and also referring to FIG. 17, a high code rate, low bit error probability underwater acoustic coherent system provided according to the present invention generally includes a host machine installed on a first ship referred as a main control ship (1) or a main control underwater vehicle A, and a guest machine installed on a second ship referred as a emitting ship (13) in FIG. 17 or alternatively an underwater vehicle B (10) as shown in FIG. 2.

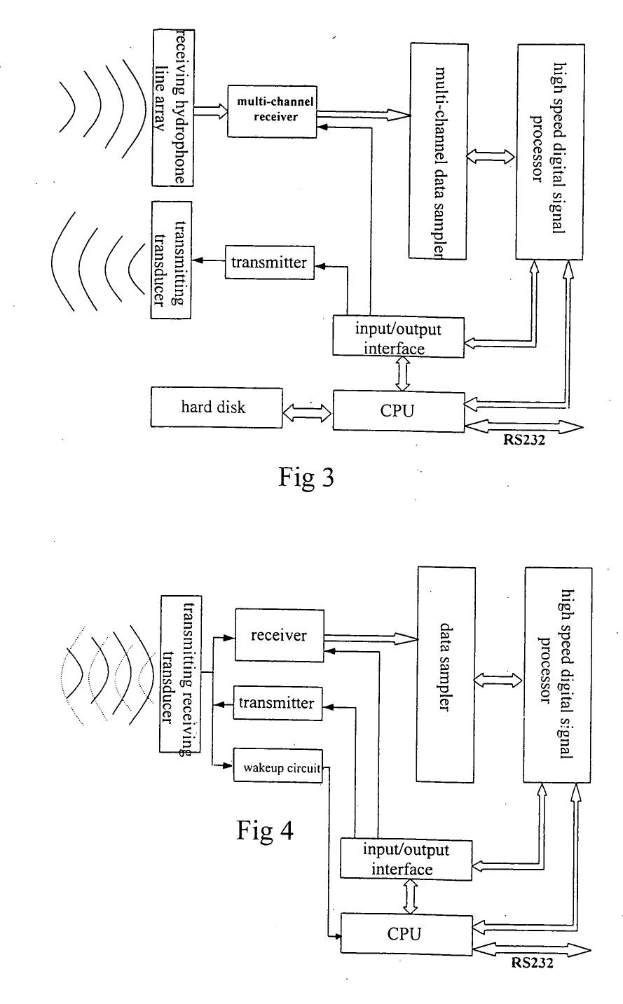

FIG. 3 illustrates a block diagram of the host machine, which comprises an electronic subassembly (2) fitted on the main control ship (1), a receiving hydrophone array (15) and a horizontal non-directive transmitting transducer (14). The electronic subassembly (2) of the host machine includes a transmitter, a multi-channel receiver, multi-channel data sampler, a high-speed digital signal processor, an input/output interface and a main controlling computer. The receiving hydrophone array (15) consists of three horizontal non-directive hydrophones, each two adjacent hydrophones being spaced approximately 10 wavelengths. The transmitting transducer (14) and the hydrophone array (15) are hung down into water with a rope (6) and a weight (7) while their cable (5) are connected to the electronic subassembly (2) in main control ship (1).

FIG. 4 illustrates a block diagram of the guest machine, which comprises an electronic subassembly (11) fitted on the emitting ship (13), and a non-directive transmitting/receiving transducer (18). The electronic subassembly ( 11) includes a transmitter, a receiver, a wakeup circuit, a data sampler, a high-speed digital signal processor, an input/output interface and a main controlling computer. The transmitting/receiving transducer (18) is hung down into water with a rope (16) and a weight (19) while its cable (17) is connected to the electronic subassembly (11) in the second ship (13).

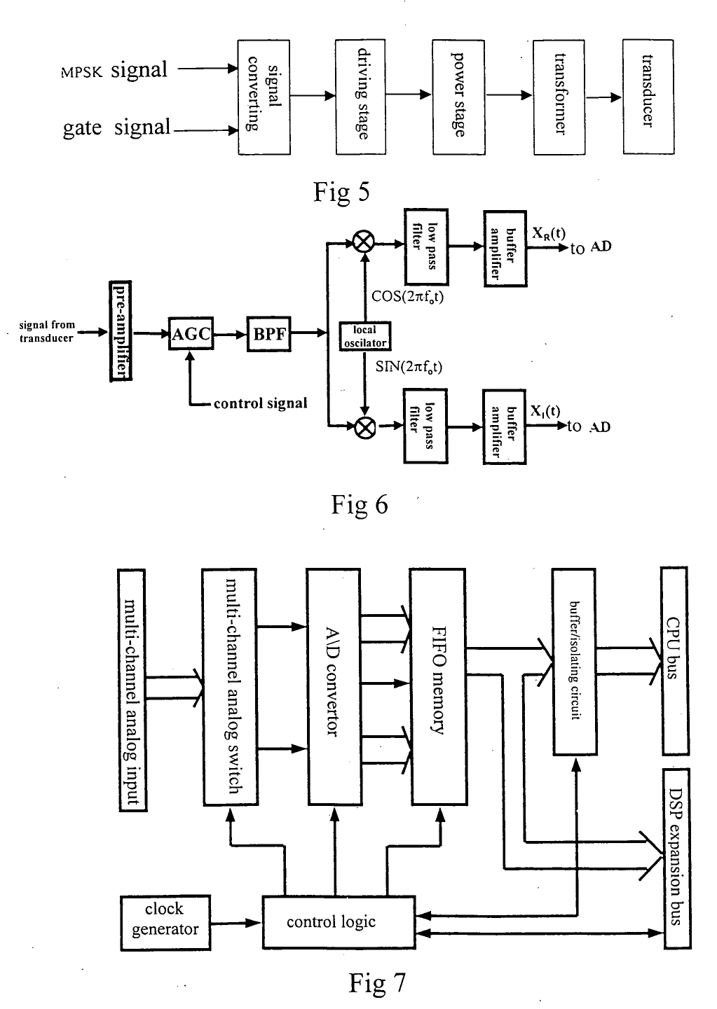

As shown in FIG. 5, the transmitters of the host machine and the guest machine include a signal converter, a driving stage, a power stage and a transformer driving a sonar array. The transformer may preferably utilize a box type ferrite material, and the ratio of the transformer may be determined based on the requirement of matching with the resistance of the transducer. The other components can be purchased on the market. The connection of the components and the working flow of the system will be described in great detail as follows.

FIG. 6 is a circuit diagram illustrating one channel of the receivers of the host machine and the guest machine of the system. The circuit of the receiver consists of a pre-amplifier, an automatic gain control (AGC) circuit, a band pass filter (BPF), a quadrature mixer, low pass filters and buffer amplifiers electrically connected in a sequence along the signal direction of the circuit. The components shown in the figure are all chips available on the market.

FIG. 7 is a block diagram illustrating the multi-channel data sampler, which consists of an analogue input, a multi-channel analogue switch (MAX308), an A/D converter (AD1671), a FIFO memory (IDT7024), a control logic, a clock generator, a bus of the main control computer and a DSP expansion bus electrically connected in a sequence along the signal direction of the circuit.

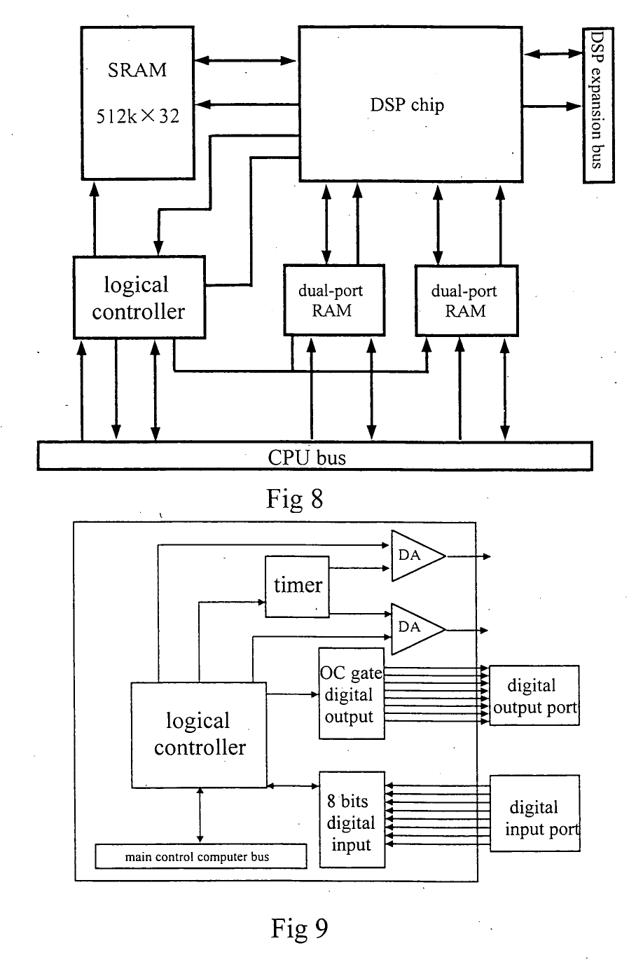

FIG. 8 is a block diagram of the high speed digital signal processor, which consists of a digital signal processing chip (TMS320C30), two chips of Dual port RAM (IDT7024), one static RAM (SRAM), a logic controller and an expansion bus electrically connected in a sequence along the signal direction of the circuit.

FIG. 9 is a circuit diagram of input/output interface, which includes a digital output port, a digital input port, a timer (8254), a D/A converter (AD7245A), a logic controller and a bus of the main control computer electrically connecting in a sequence along the signal direction of the circuit.

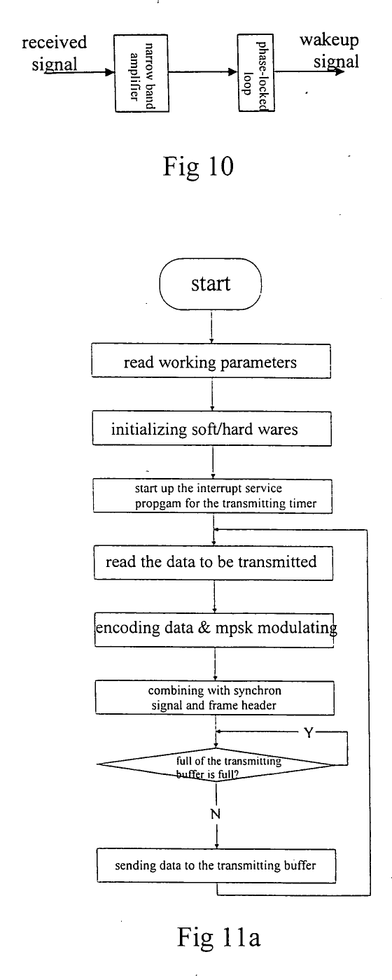

FIG. 10 is a diagram of a wakeup circuit including a narrow-band amplifier and a phase locked loop electrically connected in a sequence along signal direction of the circuit.

The above-mentioned chips from FIG. 7 to 10 are all commonly used chips.

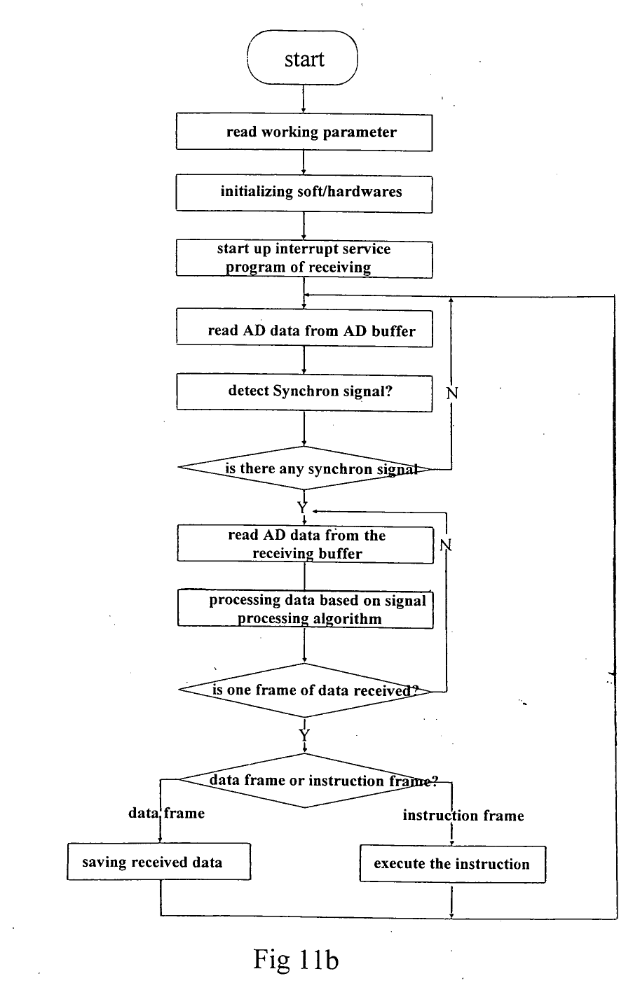

The system has a center frequency of 17.5 kHz, a bandwidth of 5 kHz. The signal modulate mode of the system is MPSK. The wakeup signal is single frequency pulse of 13 kHz. The system of the present invention performs transmitting and receiving by implementing the program according to FIG. 11a and FIG. 11b. In the transmitting, the data to be transmitted is fed to the high speed digital signal processor from the main control computer, and then combined/packed, encoded and modulated in the DSP so as to generate digital waves which subsequently passing through the DA converter of the input/output interface and then fed into the transmitter and amplified by the transmitter to drive the transmitting transducer (3) or the transmitting/receiving transducer (12), so as to to generate high-power multi-phase shift keying (MPSK) acoustic signal in water.

In the receiving, the arrival acoustic signal is received by the receiving array (4) of the host machine or the transmitting/receiving transducer (12) of the guest machine. After conditioned by the receiver, the signals are digitized by the digital sampler, then the digital signal is fed into the high speed digital signal processor, afterwards the analysis result of the digital signal processor are fed into the computer and saved in the hard disk or fed to other alternative terminals via serial ports.

The communication between the host machine and the guest machine is a half-duplex operation mode, and starts from the host machine. First, the host machine transmits a wakeup signal and then waits for the response from the guest machine. The host machine repeatedly transmits the wakeup signal until the guest machine replies. The guest machine is usually under a low power consumption status, and comes to a normal working status in case of a wakeup signal is received by the wakeup circuit and the other circuits of the guest machine is activated by the wakeup signal. When the guest machine comes to the normal working status, a response signal is sent back to the host machine. After the host machine have received the response signal from the guest machine, the data to be transmitted are combined/packed, encoded, modulated and transmitted by the host machine. The guest machine receives the sound signal and performs a real-time processing so as to recover the data transmitted from the host machine. Having the host machine completed the transmitting, the guest machine transmits data to the host machine as return. The data is combined/packed, encoded, modulated and transmitted by the guest machine. The host machine is always under the receiving status while it is transmitting. The host machine receives the sound signal and performs a real-time processing so as to the data transmitted from the guest machine.

Test Result 1

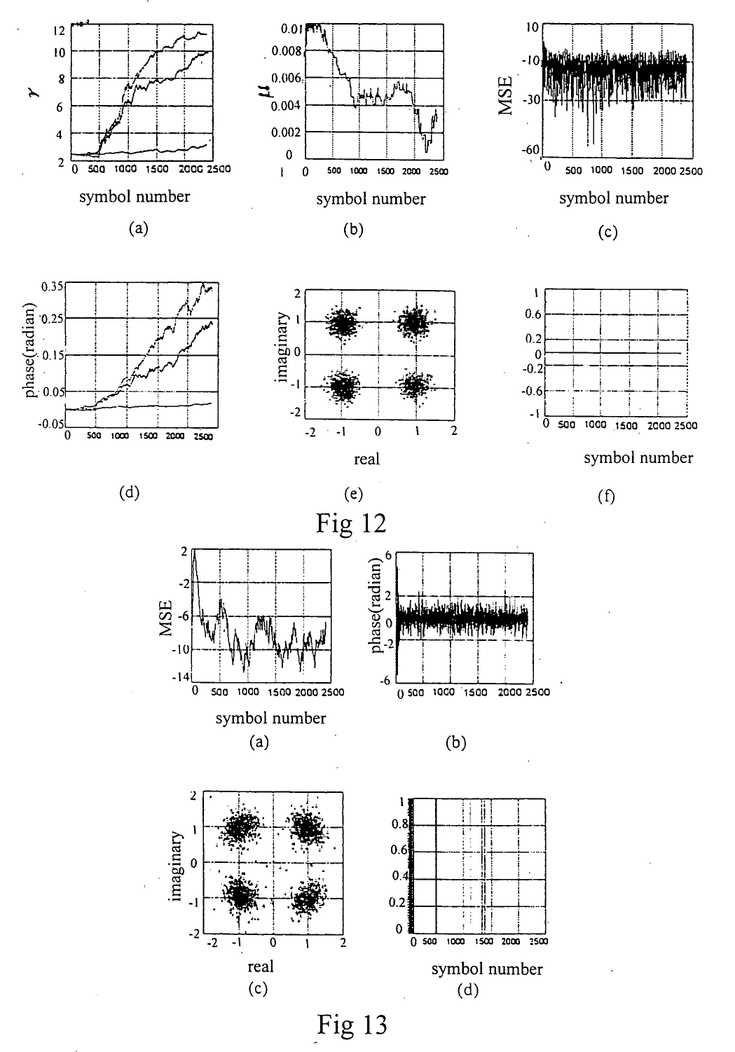

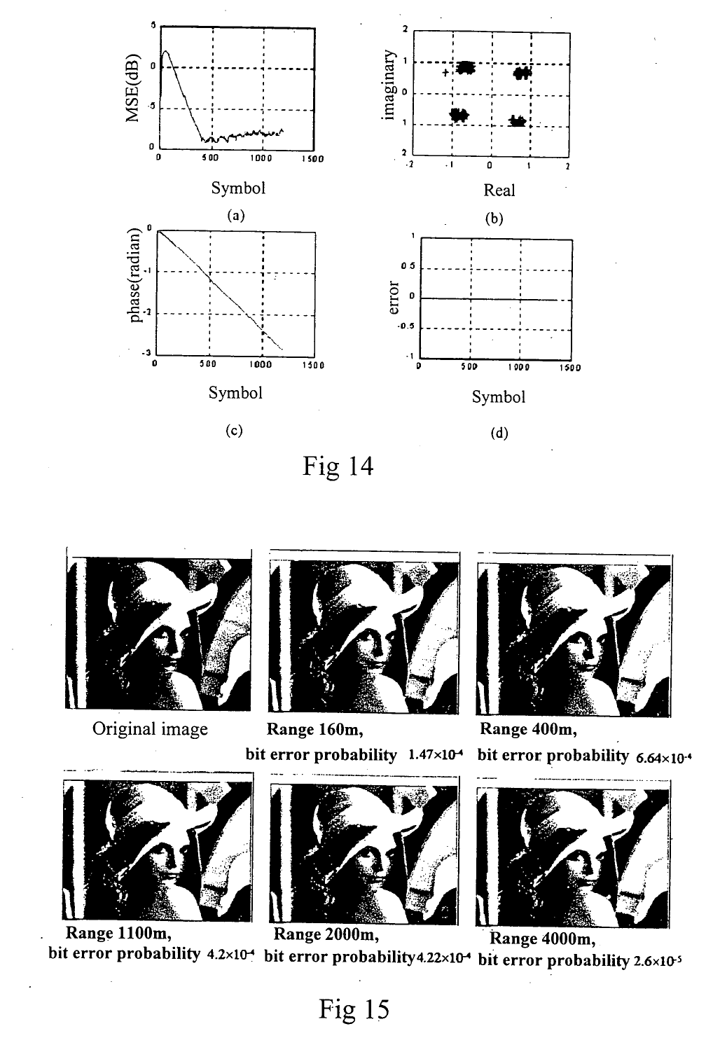

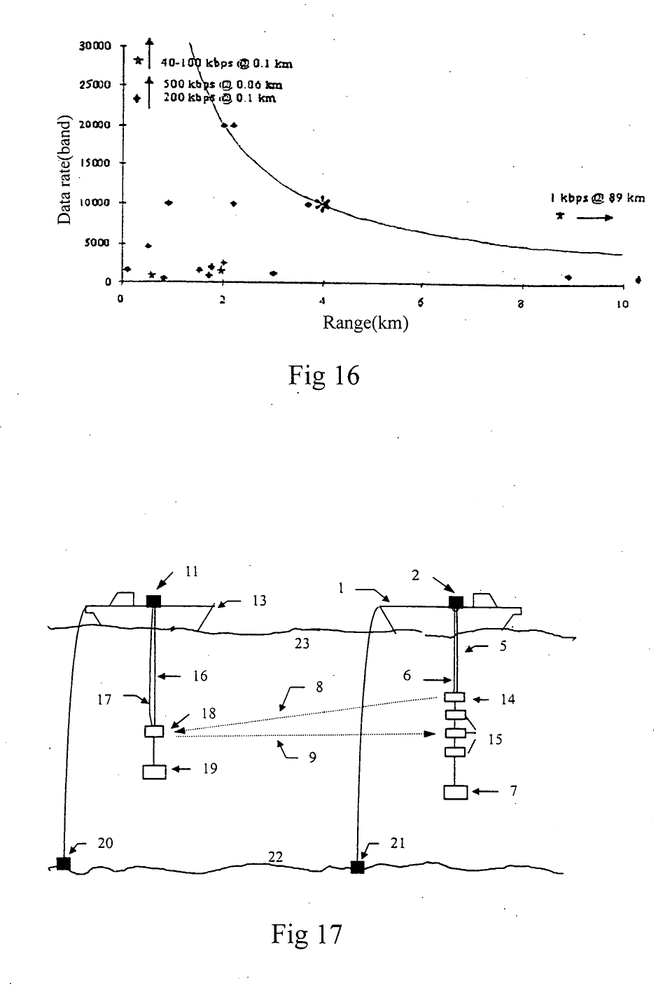

Shown in FIG. 12 is the first test result of the communication system in accordance with the present invention based on the technology of space diversity, self-optimized adaptive decision feedback equalizer and self-optimized adaptive phase tracker. As it can be seen in the FIG. 12a, the difference between gain factors [symbol] of the LMS estimator in the phase tracker of the present invention reaches one magnitude order, therefore it is difficult for the communication system of the U.S. Pat. No. 5,844,951 to detect and track such rapidly varying underwater acoustic signal phase based on the second order phase-locked loop with two fixed parameter. It can be seen in FIG. 12b, the change of the gain factor μ in the LMS signal processing of the optimization adaptive decision feedback equalizer may reach one magnitude order, therefore t is difficult for the communication system of the U.S. Pat. No. 5,844,951 to detect and track the rapidly varying underwater sound signal phase based on the fast convergent RLS algorithm with fixed exponential factor. FIG. 12 shows that at the range of 2000 meters, the communication system according to the present invention based on the space diversity, self-optimized adaptive decision feedback equalizer and self-optimized adaptive phase tracker achieves a data rate of 10 kbits/s, and a bit error probability of 1.90×10⁻⁵.

FIG. 13 shows a test result of the communication system of the U.S. Pat. No. 5,844,951 based on the space diversity, fast convergent RLS adaptive decision feedback equalizer and second order phase-locked loop phase tracker under the same test condition of the FIG. 12. It can be seen from FIG. 13, the U.S. Pat. No. 5,844,951, at the range of 2000 meters, the data rate is 10 kbit/s and the bit error probability is 1.90×10⁻². The test result is obviously worse than that of the present invention.

Test Result 2

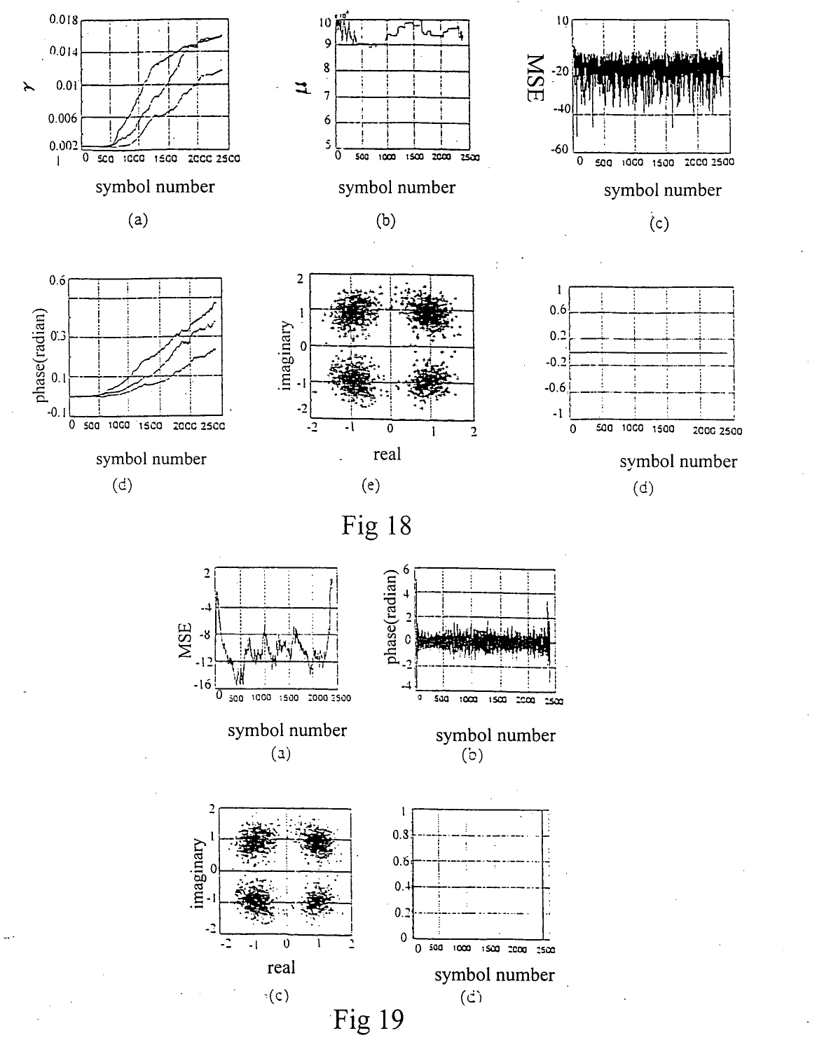

Shown in FIG. 18 is the second test result of the communication system in accordance with the present invention based on the technology of space diversity, self-optimized adaptive decision feedback equalizer and self-optimized adaptive phase tracker. As it can be seen in the FIG. 18a, the difference between gain factors [symbol] of the LMS estimator in the phase tracker of the present invention reaches several magnitude orders, therefore it is difficult for the communication system of the U.S. Pat. No. 5,844,951 to detect and track such rapidly varying underwater acoustic signal phase based on the second order phase-locked loop with two fixed parameters. It can be seen from FIG. 18b, there exists a very fast change of the gain factor μ in the LMS algorithm of the self-optimized adaptive decision feedback equalizer, therefore it is difficult for the communication system of the U.S. Pat. No. 5,844,951 to detect and track the rapidly varying underwater acoustic signal phase based on the fast convergent RLS algorithm with fixed exponential factor. FIG. 18 shows that at a range of 4000 meters, the communication system according to the present invention based on the space diversity, self-optimized adaptive decision feedback equalizer and self-optimized adaptive phase tracker achieves a data rate of 10 kbits/s and a bit error probability of 1.70×10⁻⁵.

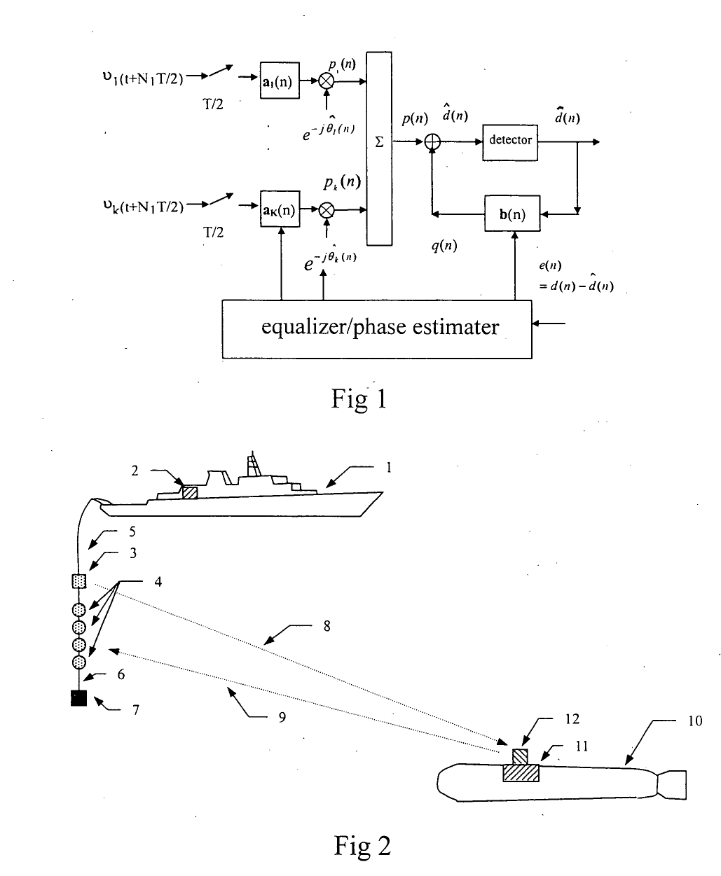

FIG. 19 shows a test result of the communication system of the U.S. Pat. No. 5,844,951 based on the space diversity, fast convergent RLS adaptive decision feedback equalizer and second order phase-locked loop phase tracker under the same test condition of the FIG. 1-8. It can be seen from FIG. 13, the U.S. Pat. No. 5,844,951, at the range of 4000 meters, the data rate is of 10 kbit/s and the bit error probability is 2.15×10⁻². The test result is obviously worse than that of the present invention.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A high code rate low error probability underwater acoustic coherent communication system, including a host machine installed on a mother ship or main control underwater vehicle A and a guest machine installed on a second ship or a second underwater vehicle B, wherein the host machine comprises a transmitting transducer, a receiving line array and an electric subassembly, the transmitting transducer and the receiving line array are lowered down into water from the mother ship or the main control underwater vehicle A and electrically connected to a transmitter and a multi-channel receiver of the electric subassembly of the host machine respectively; The guest machine comprises a transmitting/receiving transducer and an electric subassembly, the transmitting/receiving transducer is lowered down into water from the second ship or installed in the second underwater vehicle B and electrically connected to a transmitter and a receiver of the electric subassembly of the guest machine respectively. What is characterized is that the center frequency of the communication system is ranged from 7 kHz to 45 kHz, the bandwidth is ranged from 5 kHz to 20 kHz, the receiving line array of the host machine consists of 2 to 16 hydrophones and vertically deployed underwater with space from 8 to 40 wave lengths between adjacent hydrophones, each hydrophone being non-directive in the horizontal, and the receiving sensitivity frequency response satisfy the predetermined bandwidth of the system.

2. The high code rate low error probability underwater acoustic coherent communication system as claimed in claim 1, wherein said transmitting transducer of the host machine or the transmitting/receiving transducer of the guest machine may be a horizontal non-directive transducer or directive transducer with beam angle ranged from 60° to 120°.

3. The high code rate low error probability underwater acoustic coherent communication system as claimed in claim 1, wherein said electric subassembly of the host machine comprises a transmitter, a multi-channel receiver, a multi-channel data sampler, a high speed digital signal processor, an input/output interface and a main control computer, wherein the receiver is electrically connected to the multi-channel data sampler, the multi-channel data sampler is electrically connected to high speed digital signal processor, which is electrically connected to a main control computer, and the input/output interface is electrically connected to the main control computer, the transmitter and the multi-channel receiver.

4. The high code rate low error probability underwater acoustic coherent communication system as claimed in claim 1, wherein said electric subassembly of the guest machine comprises a transmitter, an single channel receiver, a data sampler, a high speed digital signal processor, an input/output interface and a main control computer, wherein the transmitting/receiving transducer is electrically connected with the receiver and the transmitter, the receiver is electrically connected to the data sampler, the data sampler is electrically connected to the high speed digital signal processor, high speed digital signal processor is electrically connected to the main control computer, input/output interface is electrically connected with the transmitter, the single channel receiver, and the main control computer.

5. The high code rate low error probability underwater acoustic coherent communication system as claimed in claim 4, wherein said guest machine further comprises a wakeup circuit, which is a low power consumption circuit with the power consumption lower than 10 mW. Its input links to the transmitting/receiving transducer and its output links to main control computer.

6. The high code rate low error probability underwater acoustic coherent communication system as claimed in claim 1, wherein the center frequency of the transmitter is ranged from 7 to 45 kHz, the bandwidth is ranged from 5 kHz to 20 kHz, the output power of the transmitter should be higher than SW.

7. The high code rate low error probability underwater acoustic coherent communication system as claimed in claim 1, wherein said multi-channel receiver of the host machine consists of 2 to 16 channel receiver, each channel is connected to one hydrophone, the center frequency of each channel is ranged from 7 kHz to 45 kHz, the bandwidth is ranged from 5 kHz to 20 kHz, each channel has a gain no less than 40 dB, and has an automatic gain control circuit and a band pass filter for filtering noise and interference.

8. The high code rate low error probability underwater acoustic coherent communication system as claimed in claim 4, wherein said, data sampler of the host machine have channels number not less than the receiver, and sampling speed for each channel is equal to or more than 4 times of the output signal bandwidth of the receiver, the bit number of the AD converter is no less than 10 bits.

9. The high code rate low error probability underwater acoustic coherent communication system as claimed in claim 4, wherein the processing capacity of said high speed digital signal processor of the host machine is not lower than 400 MIPS, the RAM is not lower than 256 k bytes, the data throughput between the digital signal processor and the multi-channel data sampler is not lower than the data output rate of the multi-channel data sampler.

10. The high code rate low error probability underwater acoustic coherent communication system as claimed in claim 3, wherein said receiver of the guest machine is a single channel receiver electrically connected with the transmitting/receiving transducer.

11. The high code rate low error probability underwater acoustic coherent communication system as claimed in claim 4, wherein the sampling rate of the data sampler of the guest machine is not lower than 4 times of the bandwidth of the receiver, and the bit number of the A/D converter is not lower than 10 bits.

12. The high code rate low error probability underwater acoustic coherent communication system as claimed in claim 4, wherein the processing capacity of said high speed digital signal processor of the guest machine is not lower than 33 MIPS, the RAM is not lower than 128 k bytes, the data throughput between the digital signal processor and the data sampler is not lower than the data output rate of the data sampler.

13. The high code rate low error probability underwater acoustic coherent communication system as claimed in claim 3, wherein said receiver of the host machine may have quadrature mixing circuits and outputs quadrature base band signal, or directly output without mixing

14. The high code rate low error probability underwater acoustic coherent communication system as claimed in claim 3, wherein said input/output interface of the host and guest machines include at least one DA output, of which the resolution is not lower than 10 bits, and the refresh speed is not less than 30 k SPS.

15. A method for processing underwater acoustic coherent signal by using the high code rate low error probability underwater acoustic coherent communication system as claimed in claim 1, which is characterized that it includes steps of: (1) signal transmitting step; (2) signal receiving step; and (3) processing step for the received signal. The signal transmitting step includes first modulating the source data, sending the modulated data to the transmitter via the input/output interface, and driving the transmitting transducer or the transmitting/receiving transducer to emit acoustic signal. The receiving step of the host machine includes converting the acoustic signal propagating to the hydrophones of the receiving line array of the host machine into electrical signal, condition them in the multi-channel receiver, and digitizing them in the multi-channel data sampler The receiving step of the guest machine includes converting the acoustic signal propagating to the transmitting/receiving transducer of the guest machine into electrical signal, conditioning the signal in the receiver, and digitizing it in the data sampler. The processing of the received signal includes: processing the digitalized signal in the high speed digital signal processor, saving the processing result in a hard disk, or send the result to other terminals via serial ports. What is characterized is that the modulating method is the multiple phase shift keying modulation, the host machine utilizes a multi-hydrophone receiving line array, a multi-channel receiver and multi-channel data sampler to realize space diversity, the processing step including processing signal based on the joint algorithm of space diversity, self-optimized multi-channel adaptive decision feedback equalizer and self-optimized adaptive phase tracker, wherein the self-optimized multi-channel adaptive decision feedback equalizer utilizes the fast optimization least mean square algorithm of, the gain factor μ of which is adjusted based on the algorithm of least mean square, the self-optimized adaptive phase tracker provides phase compensation to multi-channel signals based on the fast self-optimized least mean square algorithm, the gain factor V of which is adjusted based on the algorithm of least mean square.

16. The high code rate low error probability underwater acoustic coherent communication system as claimed in claim 5, wherein the center frequency of the transmitter is ranged from 7 to 45 kHz, the bandwidth is ranged from 5 kHz to 20 kHz, the output power of the transmitter should be higher than SW.

17. The high code rate low error probability underwater acoustic coherent communication system as claimed in claim 4, wherein said input/output interface of the host and guest machines include at least one DA output, of which the resolution is not lower than 10 bits, and the refresh speed is not less than 30 k SPS.
